(19) United States
(12) Patent Application Publication
(10) Pub. No.: US 2026/0001655 A1
(43) Pub. Date: Jan. 1, 2026

(54) EXHAUST CONE HEAT EXCHANGER (HEX)

(71) Applicant: GKN Aerospace Sweden AB, 81 Trollhättan (SE)

(72) Inventors: Henrik Strömberg, 81 Trollhättan (SE); Sonny Andersson, 81 Trollhättan (SE); Anders Lundbladh, 81 Trollhättan (SE)

(73) Assignee: GKN Aerospace Sweden AB, 81 Trollhättan (SE)

(21) Appl. No.: 18/867,929

(22) PCT Filed: Jun. 27, 2023
(86) PCT No.: PCT/EP2023/067529

§ 371 Date: Nov. 21, 2024

(30) Foreign Application Priority Data
Jun. 27, 2022 (GB) 2209392.6

(51) Int. Cl. B64D 37/34; B64D 27/10; F02C 7/224; F02K 1/04

(52) U.S. Cl. CPC B64D 37/34; B64D 27/10; F02C 7/224; F02K 1/04

(57) ABSTRACT

An aircraft fuel heating arrangement comprises an exhaust cone for a gas turbine engine, the exhaust cone having an outer body defining an internal cone cavity, the internal cone cavity comprising one or more conduits passing therethrough for communicating fuel through the cavity, and wherein the outer body of the exhaust cone comprises at least one inlet and at least one outlet to allow exhaust gas to pass into through and out of the exhaust cone.

### CROSS-REFERENCE TO RELATED APPLICATIONS

This application is a national stage of, and claims priority to, Patent Cooperation Treaty Application No. PCT/EP2023/067529, filed on Jun. 27, 2023, which application claims priority to Great Britain Application No. 2209392.6, filed on Jun. 27, 2022, which applications are hereby incorporated herein by reference in their entireties.

### BACKGROUND

Conventional gas turbine engines, of the type used in commercial aircraft, are designed to operate using a kerosene based fuel that is burnt to create engine thrust. Such engines are well known and understood in the art.

According to most estimates, airline traffic is set to double every fifteen years providing a significant increase in the pollutants that such conventional engines generate. In order to meet targets for reduction of emissions set by the International Air Transport Association, the use of alternate fuels has been identified as a possible avenue of exploration. Alternate fuels include biofuels, synthetic kerosene, compressed gases and other fuels including cryogenic fuels.

For cryogenic fuels the fuel is stored at an extremely low temperature and is heated before being burnt in an engine. Such heat can be generated in a number of ways such as by electrical heating and/or direct heating from the engine gas flows. Engine heating advantageously provides a convenient steady state arrangement in which the heat from combustion heats fuel from a cryogenic tank which can then be burnt creating heat to continue the cycle. This is a highly convenient way of operating a modified gas turbine engine using a cryogenic fuel.

### SUMMARY OF THE INVENTION

The inventors have established an improved arrangement for heat recovery which may be conveniently used and which protects the heat exchanger from any debris which may exit the engine due to failures or foreign object ingestion. An invention described herein furthermore minimises any performance penalty that might be caused due to the recovery of heat from the engine. Thus, an alternative fuel system and associated engine architecture has been realised.

Inventions described herein have particularly advantageously applications in aircraft engine design for use with non-conventional fuels such as fuels which are stored at low temperatures and which must be heated in order to combust efficiently. Most notably the inventions described herein are beneficial for gas turbine engines which are configured to operate using cryogenic fuels such as liquid hydrogen or the like.

The present disclosure is concerned with alternative aircraft propulsion systems including conventional fuels and also aircraft propulsion systems which may operate using non-conventional aviation fuels, such as cryogenic fuels.

Aspects are set out in the accompanying claims.

Viewed from a first aspect there is provided an aircraft fluid heating arrangement comprising an exhaust cone for a gas turbine engine, the exhaust cone having an outer body defining an internal cone cavity, the internal cone cavity comprising one or more conduits passing there through for communicating fluid through the cavity, and wherein the outer body of the exhaust cone comprises at least one inlet and at least one outlet to allow exhaust gas to pass into through and out of the exhaust cone.

Thus, according to an arrangement described herein hot exhaust gas which conventionally leaves a gas turbine engine can instead be used to heat a fluid using heat recovery in a heat exchanger. Unconventionally, part of an exhaust cone is used to house such a heat exchanging arrangement at the aft of the engine to recover otherwise lost heat.

Advantageously the fluid may be a fuel such as, in one example, a super-cooled cryogenic fuel which can in turn be used to fuel the engine.

For example, liquid hydrogen may be used in a cryogenic form. Also, liquid methane or LNG or liquid ammonia may be used in accordance with inventions described herein.

A fluid inlet and fluid outlet may be provided at suitable locations on the conduit allowing for fluid to be communicated to and from the conduit(s) within the cavity. The inlet may be in communication with a tank and the outlet in communication with a fuel or fluid delivery system of an engine.

The one or more conduits may be arranged so as to cause fluid fuel to flow in a generally alternating direction between the fore and aft (front and rear) of the cone in an exhaust gas flow direction. This advantageously maximises the fluid path length and increases the heat transfer capability of the conduit through thermal heat transfer through the conduit wall.

The one or more conduits may be in the form of a generally cylindrical heat exchanger having a plurality of pipes extending between the fore and aft of the cavity and defining one or more fuel fluid flow paths within the cavity. Such a cross-section advantageously fits within the cone of an engine and optimises space usage and thereby efficiency.

The volume of exhaust gas flowing through the exhaust cone and over the conduits may be predetermined and the inlet(s) and/or outlet(s) selected to allow a predetermined percentage or volume of exhaust gas to pass through the cone. The predetermined volume of gas may be established, for example, to be optimised for heat transfer at cruise speed and altitude for a given engine.

Alternatively, the volume may be selectively controlled, for example by means of a controllable aperture/door/moveable vane or the like (to control exhaust gas flow volume), to control the heating effect of the exhaust gases through the cone by controlling the volume of exhaust gas that it directed through the cone from the exhaust. Controlling the volume of exhaust gas passing through the cone allows the heat transfer to the conduits to be finely controlled and adapted over different flight/taxi and operating conditions. This can avoid too high and too low fluid or fuel temperatures. A suitable control feedback arrangement may for example be provided to control the exhaust gas volume flow in response to fluid/fuel temperature.

The spacing between adjacent one or more conduits may increase towards the central axis of the heating arrangement. Thus, the conduit density towards the central axis of the arrangement decreases. Specifically, the matrix should be dense at the outer radius and more sparse towards the center. This will limit flow velocities and pressure drop towards the center of the heat exchanger.

The conduits may be arranged parallel to the axis of the heating arrangement. Advantageously, the conduits or tubes will spiral from the inside (cold fuel or fluid, and cold exhaust) to the outside (hot fuel and hot exhaust).

The conduits may advantageously be divided into discrete groups, each group forming a sub-set or module of a heating arrangement body. In effect the heating arrangement can be divided into segments of a cylinder, each segment being similar or identical. Advantageously the modules may each be located into the heating arrangement axially and be removable for maintenance or the like. In effect, each module may be selectively removable from the heating arrangement.

One, a subset, or all of the modules may be fluidly interconnected at one or both ends of a module to an adjacent module. Thus, selective flow lengths can be provided or alternatively a maximum flow length path can be created through module interconnections.

Hot exhaust gases may be communicated into the heating arrangement in a variety of ways i.e. directed from the engine exhaust. For example, at least one inlet may be is in the form of one or more annular circumferentially extending inlet(s) arranged in use to communicate exhaust gas from an exhaust of an associated engine into the cavity. Thus gas can conveniently be received uniformly around the heating arrangement and evenly distributed therethrough.

The outlet from the cavity may be axially located with respect to the axis of rotation of the exhaust cone to allow the gas to leave the cone and engine along the axis of travel of the engine.

The cavity itself may comprise a plurality of conduit supports/baffles extending across a portion of the cross-sectional area of the exhaust cone and comprising a plurality of apertures arranged to receive and support an associated conduit. Thus, the conduits can be supported to provide mechanical strength during flight and operation. The baffles may advantageously allow for thermal expansion of the conduits.

The supports/baffles may for example be spaced along the length of the cavity from exhaust inlet to exhaust outlet. Furthermore, the supports/baffles may have increasing outer radii towards the exhaust outlet. Increasing the outer radius of consecutive baffles allows gas flow control to be provided, specifically exhaust gas can be divided into a plurality of channels, each channel having exhaust gas collected by a baffle.

The supports/baffles may each have a generally truncated cone shape and comprise a central open end for communicating exhaust gas towards the exhaust of the tail cone. Furthermore, the sides of each generally truncated cone shape may comprise a concave curved profile when viewed in cross-section. Such a profile advantageously optimises gas flow over the conduits and towards the outlet.

The tubes or conduits described herein may be collected into a number of individual modules each containing one or more groups of tubes for the fluid or fuel, where each group consist of a sequence of tubes, each positioned at specific radii from the inner to the outer radius of the heat exchanger. The aforementioned groups may be arranged so that the tubes are connected together by u-bends at either end so as to form a continuous path for fluid or fuel. The radial positioning of corresponding tubes in adjacent modules may be replicated so as to provide a uniform heat exchanging arrangement with multiple modules.

The groups or modules may each be arranged in a general segment or wedge shape when viewed along the axis of rotation of the engine.

The heating arrangement may be configured as a pair of heat exchanger with a primary heat exchanger which communicates heat to a fuel for consumption in the engine. The primary heat exchanger may receive fuel from a fuel tank or vessel and communicate fuel to the engine. This may be located within the engine cowling, the aircraft fuselage or proximate to the fuel tank.

The heat exchanging arrangement within the cone may then function as a secondary heat exchanger with fluid flowing through the secondary heat exchanger to the primary heat exchanger.

Thus, the fuel may advantageously be heated from heat received from the one or more conduits passing through the exhaust cone. A fluid circulates through the secondary heat exchanger and collects heat from the exhaust gas. The fluid then circulates through the primary heat exchanger when the heat from the fluid is exchanged to the fuel and the fuel is then communicated to the engine.

Advantageously in such an arrangement the fuel itself is not communicated through the conduits in the exhaust cone but instead is circulated through the primary heat exchanger. Such an arrangement reduces the risk of fuel leakage within the exhaust cone. The fluid within the conduits of the exhaust cone may advantageously be any suitable inert fluid such as, but not limited to, liquid metal, helium, nitrogen, water or carbon dioxide.

Such an arrangement further reduces the risk of ice formation in the heat exchanging conduits and prevents fire or hazards should the conduits become damaged.

Viewed from another aspect there is provided a cryogenic fuel or fluid heating arrangement for a gas turbine engine, the arrangement comprising a heat exchanging apparatus contained within an exhaust tail cone of a gas turbine engine, the exhaust tail cone having an outer body defining an internal cone cavity, the internal cone cavity comprising a heat exchanger in fluid communication with a cryogenic fuel or fluid tank and an engine fuel or fluid system, wherein the outer body of the exhaust cone comprises at least one inlet and at least one outlet to allow engine exhaust gas to pass through the heat exchanging apparatus to transfer energy from the exhaust gas to the cryogenic fuel.

Advantageously the volume of exhaust gas flow may be selectively controlled in response to control signals from a control apparatus. Thus, heat transfer control can be provided.

The cryogenic fuel fluid may be a variety of fuels for example including liquid hydrogen.

Viewed from yet another aspect there is provided a method of heating a fuel or fluid for a gas turbine engine, the engine comprising a fuel or fluid heating arrangement comprising an exhaust cone for a gas turbine engine, the exhaust cone having an outer body defining an internal cone cavity, the internal cone cavity comprising one or more conduits passing therethrough for communicating fuel or fluid through the cavity, and wherein the outer body of the exhaust cone comprises at least one inlet and at least one outlet to allow exhaust gas to pass into through and out of the exhaust cone, the method comprising the steps of:
(a) causing fuel or fluid to be communicated into the conduit(s) from a fuel or fluid source;
(b) causing exhaust gas from the engine to pass through the exhaust cone and around the conduits to cause heat transfer to the fuel or fluid contained therein; and
(c) communicating heated fuel or fluid to a gas turbine engine.

Viewed from yet further aspects there is provided:
an aircraft engine comprising a fuel or fluid heating arrangement or a cryogenic fuel or fluid heating arrangement as described herein.
an aircraft comprising one or more engines comprising a fluid or fuel heating arrangement or a cryogenic fuel or fluid heating arrangement as described herein; and
a vehicle or power generation apparatus comprising a fuel or fluid heating arrangement or a cryogenic fuel or fluid heating arrangement as described herein.

### BRIEF SUMMARY OF THE DRAWINGS

Aspects of the disclosure will now be described, by way of example only, with reference to the accompanying figures in which:

FIG. 1 shows a conventional tail cone of a gas turbine engine;

FIG. 2 shows a cross-section through a conventional gas turbine engine illustrating the location of the exhaust cone and associated exhaust nozzles;

FIG. 3 shows a cross-section through an arrangement described herein;

FIG. 4 show a cross-section through an arrangement described herein with exhaust flows and exhaust inlet ports;

FIG. 5 shows a cross section through a cone described herein showing exhaust gas flows;

FIGS. 6A and 6B show alternative baffle arrangements;

FIGS. 7A to 7E show the arrangement of conduits within the cone cavity forming a heat exchanging apparatus;

FIGS. 8A to 8E show supports or baffles located with the exhaust cone of an arrangement described herein;

FIGS. 9A and 9B show conduit distribution and end connections; and

FIGS. 10A to 10D show conduit module arrangements.

While the invention is susceptible to various modifications and alternative forms, specific embodiments are shown by way of example in the drawings and are herein described in detail. It should be understood however that the drawings and detailed description attached hereto are not intended to limit the invention to the particular form disclosed but rather the intention is to cover all modifications, equivalents and alternatives falling within the spirit and scope of the claimed invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

It will be recognised that the features of the aspects of the invention(s) described herein can conveniently and interchangeably be used in any suitable combination.

### DETAILED DESCRIPTION

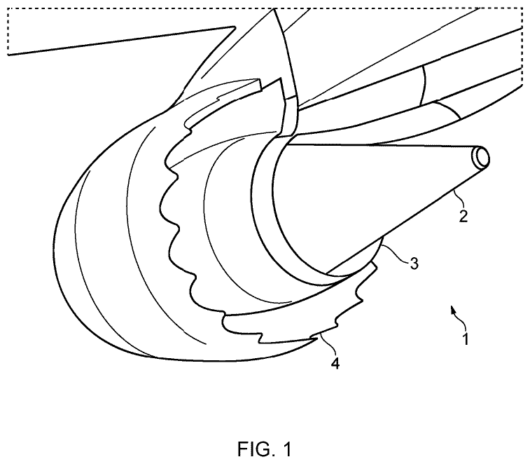

FIG. 1 shows a general view of a gas turbine engine 1 viewed from the aft of the engine looking forwards i.e. towards the direction of flight. The rear of the engine comprises a tapered exhaust cone 2 which provides an aerodynamic final profile to the tail or rear end of the engine.

Engine core exhaust gas passes out of annular outlet 3 of the engine, to combine with the fan airflow exhaust 4 to create engine thrust. The engine exhaust cone 2 acts primarily as an aerodynamic component of the engine.

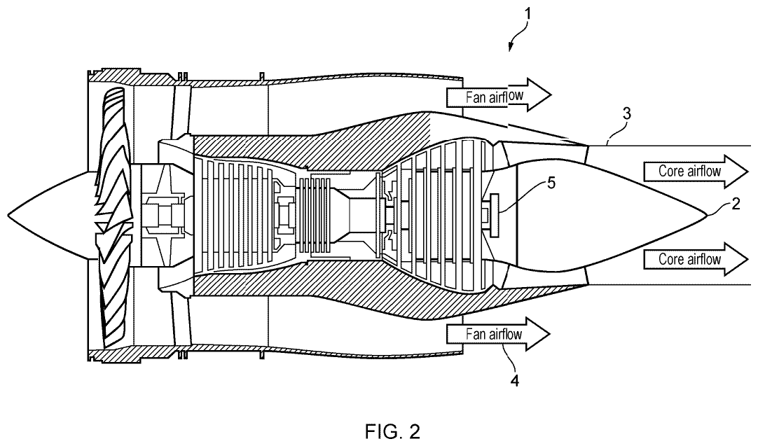

FIG. 2 shows a cross-section of an example gas turbine engine. As shown the exhaust cone 2 is located at the aft (rear) of the engine and is surrounded by an annular core exhaust 3. This flow is exhaust gas leaving the combustors. Radially outwards of the core exhaust 3 is an annular fan airflow exhaust 4.

The function of the gas turbine inlet, compressors and combustors (as shown in cross-section in FIG. 2) will be well understood by a person skilled in the art and will not be discussed in detail. The inventions described herein are concerned with the exhaust cone and a novel fuel management system.

FIG. 2 illustrates the general flow around the exhaust cone which is smooth and tapered to reduce drag and eddy currents propagating from the rear of the engine. The exhaust cone therefore exhibits a smooth and aerodynamic outer surface. The exhaust cone is generally sealed so as not to cause any drag but may incorporate a small outlet to allow gases to escape from the main shaft bearings 5 located along the axis of the engine.

The exhaust cone is, as shown, located at the aft end of the engine and it is therefore desirable to minimise the weight of the cone so as to reduce overall engine weight and to reduce the moment or turning force a weight at the rear of the engine may cause on the engine and engine mounts

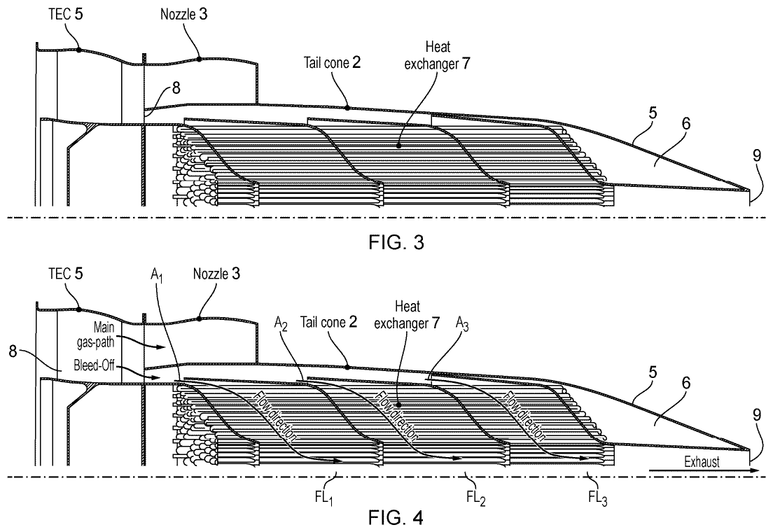

FIG. 3 shows a cross-section of an exhaust cone. The cone 2 is mechanically coupled to the turbine exhaust casing (TEC) which is a structural part of the engine. Attached to the TEC is also the core exhaust nozzle 3 which is an annular and circumferentially located ring surrounding the engine which allows exhaust gases to accelerate rearwardly as will be understood in the art.

The cone may be coupled to the TEC in a variety of ways. For example, a first baffle or left hand wall of the heat exchanger compartment may be connected to the rear, inner flange of the TEC. The cone may then be attached to this baffle with radial struts going outward from the first baffle. The other baffles may then be attached with similar radial struts going inward from the cone to each baffle. The tubes are then suspended from the baffles, although some axial relative motion may be possible at least at some of the baffle/tube intersections to limit build-up of thermal stresses.

An alternative is to provide the TEC with a split flow path i.e. place a cylinder (concentric with engine axis) somewhere between the hub and the tip of the TEC struts, separating them into inner and outer parts. This splitter can then extend rearwards from the TEC struts, and the cone can be fixed directly to this one. As for the previous solution, radial struts from the cone can be used to suspend the baffles and indirectly the heat exchanger.

Still another alternative is to suspend the cone by means of radial struts from the outer nozzle. This in effect creates a second TEC with some associated weight and pressure drop and may not be preferred. As the gases accelerate rapidly in the nozzle the pressure drop may be large, unless the nozzle is made longer with no or minimal acceleration in the front part.

As shown the exhaust tail cone extends from the TEC rearwardly and defines a smooth outer aerodynamic surface against which exhaust gas may flow and is adapted to enclose the heat exchanger.

As shown in the cross-section in FIG. 3, the exhaust cone has an outer surface defining the outer geometry of the cone and enclosing an internal volume or cavity 6.

According to an unconventional exhaust tail cone arrangement described herein, a conduit arrangement is located within the volume or cavity 6, as described below.

As shown in FIG. 3, according to an embodiment of an invention described herein, a heat exchanging conduit 7 is located within the cavity 6. The conduit 7 may be in a plurality of different configurations, as described below. The heat exchanging conduit or conduits are configured so as to be contained within the cavity 6.

As also shown in FIG. 3 the cavity incorporates an inlet 8 and an outlet 9. The inlet 8 may be an annular inlet communicating with the exhaust nozzle to allow for the communication of exhaust gases from the exhaust nozzle into the cavity 6 through the inlet 8. It may alternatively be a plurality of discrete inlets located around the periphery of the cone or a single annular inlet allowing exhaust gas into the cone. In each configuration the purpose of the one or more inlets is to allow for the passage of exhaust gases exiting from the nozzle into the cavity of the exhaust cone.

The conduit(s) may be arranged in any suitable configuration within the cavity 6. In one arrangement the conduit(s) are arranged to receive a fuel (or fluid) for the gas turbine engine and to allow heat from the exhaust gases circulating around, or passing through the cavity to be transferred from the exhaust gas, through the walls of the conduit or conduits and to the fuel. In effect an exhaust heat exchanger is provided within the exhaust tail cone of the gas turbine engine.

Fuel or another fluid may therefore enter the conduit/heat exchanger at a first temperature T¹ and leave the conduit/heat exchanger at a second elevated temperature T² where T²>T¹. Thus, in an arrangement where a cryogenic fuel is to be used to fuel the gas turbine the cold cryogenic fuel can be elevated in temperature by means of the tail cone heating arrangement described herein. Fuel can be communicated from the cryogenic fuel tank and into the conduit of the exhaust tail cone. Heat from the exhaust gases that would normally be exhausted to atmosphere from the engine can be recycled and used to elevate the temperature of the cryogenic fuel. Specifically, the engine cycle performance can be improved by recovery of heat from the exhaust gas, which will give a lower specific fuel consumption.

As described herein a fuel may be communicated through the conduits or a fluid, which in turn may be used to transfer heat to a fuel, for example through a second heat exchanger as described herein.

The fuel or other fluid may be of a variety of fuels including but not limited to cryogenic or, at higher temperatures depending on storage and preheating in another heat exchanger, air (compressed), water, steam, another inert gas or fluid such as helium, nitrogen, oxygen depleted air, refrigerants, carbon dioxide or silicone oil. Inert mediums can be used to heat the fuel indirectly or used in a power producing cycle, separate or interconnected with the main engine

This functionality will be particularly useful if other fuels that are not based on hydrocarbons (or intermediate fluids) are used. The use of hydrogen as jet fuel will most likely be in cryogenic state, which will reduce the size of the tanks and as well as it enables pumps to be used to transport the fuel. Since the hydrogen can be heated without forming deposits, recovering heat from the exhaust gas will improve the cycle performance, which will reduce the fuel consumption of the engine.

Advantageously locating the conduits forming the heat exchanging arrangement within the tail cone protects the conduits from any debris, particles, ice or (in an extreme situation) engine component passing through the engine. Furthermore, the generally unused volume of the cone can conveniently house the heat exchanger described herein.

As also shown in FIG. 3 the conduits may be arranged as a group of bundle of tubes extending along the cone substantially parallel to the axis of the engine and alternating backwards and forwards with U-bend joints at either end. This maximises the length of the conduit thereby also maximising the area of heat transfer by increasing the ‘wetted’ surface i.e. the surface against which the hot exhaust gas will contact and impinge. Any suitable configuration of conduit may be used depending on desired heat transfer capacity, exhaust gas temperatures, length of tail cone, require temperature differential between conduit inlet and outlet and other factors.

The outlet 9 is, as shown, located along the central axis of the engine at the rear of the tail cone. This thereby minimises turbulence as gases leave the exhaust cone to blend with the other exhaust and surrounding gases

Thus, exhaust gas may enter the exhaust cone through the inlet 8, interact thermally with the conduits, transfer heat thereto and then leave the cone through the outlet 9. The contents of the conduits e.g. fuel or heat transfer fluid may similarly enter the conduit from the fuel store/tank, interact thermally with the exhaust gases and increase in temperature and then be communicated to the engine.

FIG. 4 shows the general flow of exhaust gas in one embodiment of an invention described herein.

The inventors have established that enhancement of the engine cycle efficiency through recovery of heat from the exhaust gas has a performance penalty in the pressure loss induced by the heat exchanger. Since the total heat flow in the exhaust gas is several orders of magnitude higher than the energy that is targeted to be recovered by the heat exchanging arrangement 7, only a fraction of the core flow needs to be used as a heat source in the heat exchanging arrangement. Furthermore, the amount of heat required to heat the fuel by the desired amount may change depending on operating and ambient temperatures.

Thus, only a fraction of the core flow will then be subject of performance penalty from the heat transfer process. By introducing a flow split to bleed off a fraction of the core flow, the problem of excessive pressure drop may be solved.

It has been established that this is particularly useful when liquid hydrogen is used as fuel. Since such fluid will be stored at cryogenic temperatures it is necessary to heat the fluid in order to mitigate risks related to condensate and forming of ice on the exterior of the fuel system, as it is not possible to predict the extension or form of the ice volume created.

Thus, the flow of exhaust gas through the heat exchanging or heat transfer arrangement may advantageously be controlled or throttled to allow for the desired heat transfer conditions within the tail cone cavity. Flow into and out of the cavity may be achieved by controlling the inlet through a suitable valve arrangement or controlling the outlet, again through a suitable outlet valve arrangement. A combination of both may also be used. Suitable valve arrangements are not described herein but will be understood by someone skilled in the art.

In such an arrangement suitable temperature sensors to sense the temperature of fuel and/or exhaust gases may be used in conjunction with a suitable control arrangement to control valves and fuel flow to achieve the desired fuel temperature before supply to the engine. A recycling flow may also be used to recirculate fuel to achieve a higher temperature and avoid icing. This may be realised by any suitable fluid control arrangement.

As also illustrated in FIG. 4 the flow of gas may itself be sub-divided within the cavity thereby distributing the flow evenly in the heat exchanger matrix, in order to minimize the pressure drop and maximize the heat transfer. As shown the gas flow may be divided into 3 separate flows FL₁, FL₂ and FL₃. However, any suitable number of flows may be provided. For example, too many divisions results in higher weight and pressure drop, too few divisions, more uneven flow and higher pressure drop. The number is optimised for the engine operating conditions.

The flow of exhaust gas is generally radially inwards and then axially outwards of the cone through the outlet 9. The three exhaust gas flows FL₁, FL₂ and FL₃ and formed by dividing the primary exhaust flow into the cavity from the inlet 8 into the three divergent flows. This is achieved by the sub-apertures A₁, A₂ and A₃ associated with FL₁, FL₂ and FL₃ respectively.

The sub-apertures A₁, A₂ and A₃ may be annular openings allowing exhaust gases to conveniently be captured from the inlet 8 and directed through the flow directions FL₁, FL₂ and FL₃ and over the heat transfer conduits. The sub-apertures may each be staggered radially as shown in FIG. 4 to evenly distribute or share the inlet exhaust gases from inlet 8.

FIG. 5 illustrates the overall airflows through the exhaust cone fuel heating arrangement. As shown exhaust gases leave the combustors and approach the exhaust cone. A portion of the exhaust gas is then bled off—either in a fixed volume or selectively in response to the desired heating within the exhaust cone. For example on take-off or engine start a larger proportion of heat may be desired into the cone. Similarly in extremely cold conditions an increase amount of cone heating may be desired. Conversely, in hot conditions or in cruise conditions it may be desirable to control the exhaust gas flow into the cavity.

As shown in FIG. 5 the gas is divided into a plurality of streams that pass through the heat exchanger as illustrated by the gas flow arrows of FIG. 5. As shown each flow path is controlled by an upstream and a downstream baffle to direct the gas flow through the heat exchanger and out of the rear of the cone. The baffles act to control the gas flow and then restore an axial flow of gas from the rear of the cone as illustrated by the gas flow arrows.

Thus, a feedback control arrangement may be provided to accurately manage the engine fuel inlet temperature by selectively:
(a) Controlling the amount of exhaust gas flowing into and out of the exhaust cone; and/or
(b) Optionally recirculating the flow to increase temperature of the conduit.

As shown in FIG. 5 the exhaust gas passes through the exhaust cone and leave the cone axially at the rear of the engine according to one embodiment of an invention described herein.

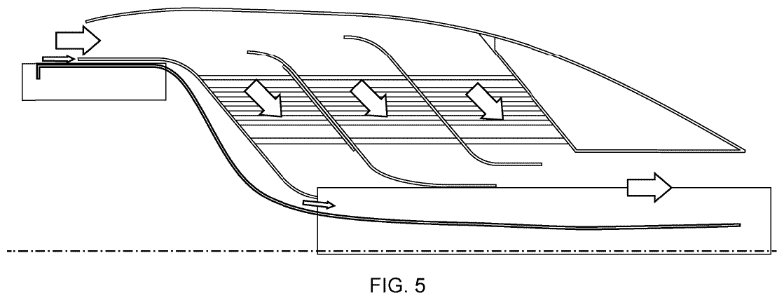

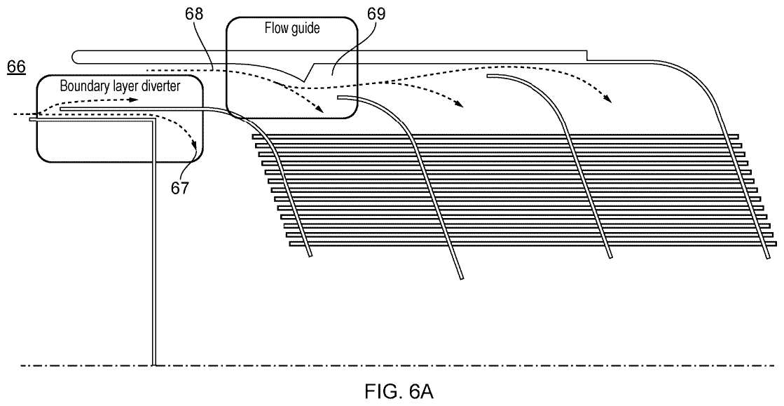

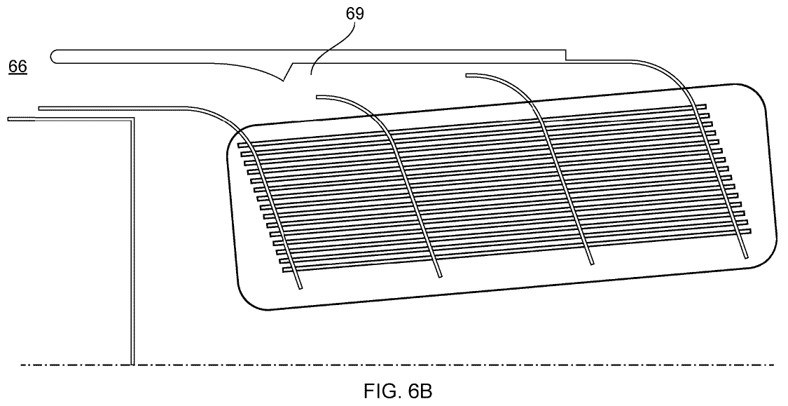

FIGS. 6A and 6B show alternative configurations of heat exchanger and specifically gas flow control.

FIG. 6A comprises an inlet 66 of exhaust gas flow from the engine. The inlet gas flow is then divided into 2 streams; a first boundary layer flow 67 of exhaust gas that passes along the surface of the engine outlet and a second main flow 68. The arrows shown in FIG. 6A illustrate schematically how the 2 flows pass through the heat exchanger.

The first flow 66 is directed quickly towards the centre of the heat exchange and towards the outlet of the heat exchanger. Conversely the main flow 68 is divided into a plurality of flows, each flow passing over a different longitudinal portion of the heat exchanger. As shown the flows are separated and controlled by the relative radial extent of the apertures.

FIG. 6A also shows a flow guide 69 which acts as a dump diffuser to cause gas to flow towards the distal end of the heat exchanger and the final aperture. The dump diffuser has the effect of reducing speed but provides a significant flow loss as the lost kinetic energy creates turbulence and then heat, instead of being available as more valuable mechanical energy. Furthermore, the dump diffuser can provide even distribution between the heat exchanger sections. Although it may create a small penalty in performance, it advantageously ensures an even distribution amongst the sections.

FIG. 6B shows a similar configuration including the flow guide 69 but in this example the conduits are inclined with respect to the rotational axis of the engine.

Advantageously such an arrangement may provide additional advantages including:
smaller turning of the flow in and out of the heat exchanger;
more space centrally towards the right where the flow increases (fed by all the sections of the heat exchanger);
a reduction in speed/flow loss;
an increase in space radially in the outer space towards the left end, where the flow is larger; and
an increase in the central space towards the left end of can be used for heat exchanger tubing (and an increase in heat transfer capacity)

Furthermore, there is provided an increase in the flow area in the center for the flow when it leaves the heat exchanger matrix. As more gas from the different sections joins the stream in the center, the flow area is advantageously increased to keep the velocities low. This achieves a more favourable flow angle with the tubes without having to turn the flow 90° inwards.

It will be recognised that an invention described herein is not limited to purely axially arranged tubes or an exactly cylindrical heat exchanger matrix.

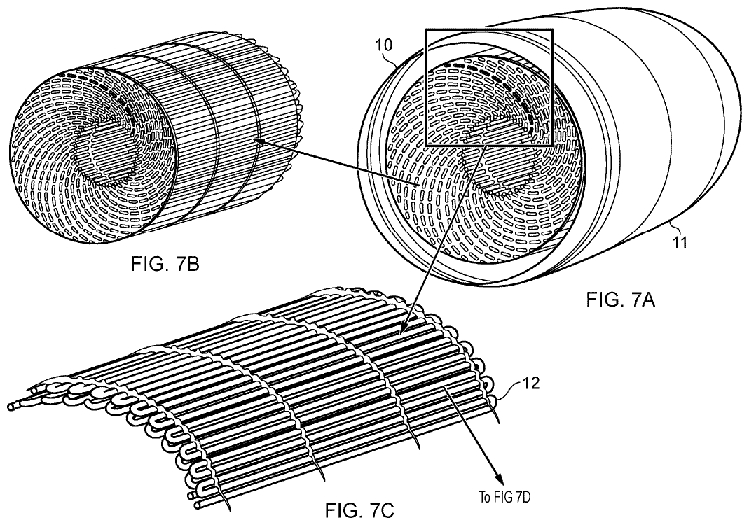

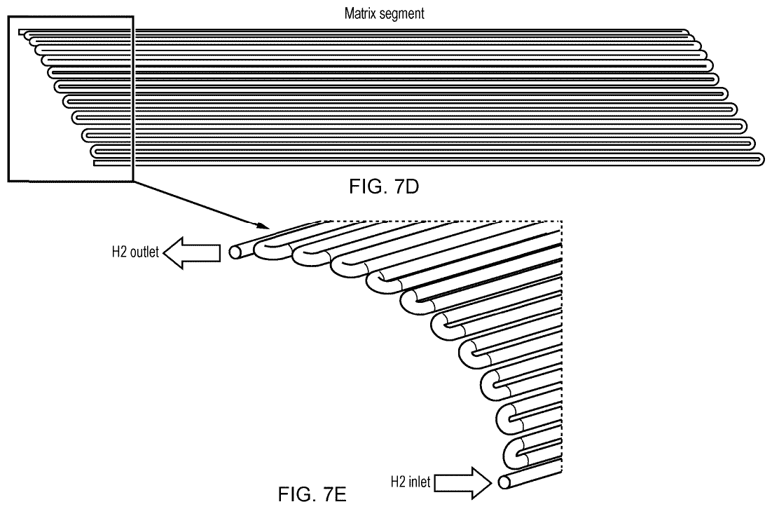

FIGS. 7A to 7E illustrate one configuration of the heat transfer arrangement contained within the exhaust cone cavity according to an invention described herein.

FIG. 7A illustrates an end and side view of an exhaust cone containing a plurality of heat transfer conduits or pipes. End 10 illustrates the up-stream end of the heat transfer arrangement i.e. the end receiving exhaust gases from inlet 8 shown in FIG. 4 and end 11 illustrates the down-stream end of the heat transfer arrangement i.e. the end exhausting gas to the outlet 9 shown in FIG. 4.

As illustrated the conduits are bundled to form a closely arranged heat exchanging matrix within the cone cavity. It will be appreciated from FIGS. 7A to 7E that the individual conduits are spaced from one-another to allow for the exhaust gases to circulate around the surfaces thereof so as to allow for the transfer of heat.

As also illustrated in FIGS. 7A to 7E the conduits are, importantly, closely aligned so as to (a) reduce the overall size of the heat exchanging arrangement and (b) reduce the overall weight distribution of the heat exchanging arrangement.

Specifically, one embodiment described herein comprises a conduit arrangement with a tube design as shown in FIGS. 7A to 7E wherein the tubes has a high heat transfer coefficient. This advantageously minimises weight and size while fulfilling the performance objectives for the desired heat transfer.

FIG. 7B illustrates the bundle or matrix of heat exchanging conduits. Advantageously the bundle may be located into the exhaust cone in a single unit thereby facilitating manufacture and/or maintenance. As shown the individual conduits forming the heat exchanging arrangement are configured into a generally spiral shape as shown in FIGS. 7A and 7B.

The spiral or helical arrangement of conduits of the matrix may provide a number of advantages including:
(i) Multi-pass counter cross flow heat exchangers for optimal heat transfer,
(ii) Easy to connect tubes in segments; and
(iii) Enables the pressure loss of the fluid to be heated to achieve a sufficiently high value, which is preferred to avoid misdistributions.

An advantage of the proposed solution shown in FIGS. 7A to 7E is a recovery of energy that is fed into the fuel system. This will have a positive impact on the engine cycle efficiency.

The arrangement shown in FIGS. 7A to 7E is formed of a plurality of individual conduits bundles or units which together form the cylindrical matrix shown in FIG. 7B. The matrix is formed of a plurality of individual groups as show in FIG. 7C. These groups extend in a curve as illustrated in the boxed area of FIG. 7A where the sub-group of conduits of 7C is located. As shown the sub-group 7C curves radially inwards which minimises the overall size of the heat exchanging arrangement.

FIG. 7D illustrates the make-up of the sub-group 7C which is in the form of a pair of curved and reciprocating conduits; each conduit in the form of a series of straight sections and U-bend end sections creating a serpentine or ‘back and forth’ configuration of pipe or conduit as shown in FIG. 7D.

The straight sections of conduit may be configured to extend generally towards the aft of the engine i.e. from fore to aft of the tail cone. This can maximise the length of the conduit within the cone cavity volume.

Advantageously the conduits may further be configured in a spiral or helix from the inlet to the outlet. Exhaust gas passing through the tail cone will comprise a swirl or rotating component by virtue of the exhaust gases leaving the engine turbine. Angling the conduits to complement the rotation or swirl of the exhaust gas further prevents debris damage.

The conduits may be supported by a plurality of braces or supports 12 (which may be baffles) which maintain the spacing between adjacent conduits to allow for exhaust gas flow. The supports may be configured to allow the conduits to move axially to accommodate thermal expansion of the conduits in operation. This is particularly relevant for longer lengths of conduit when the thermal expansion may be more prevalent.

FIG. 7D shows one layer of the conduits shown in FIG. 7C. FIG. 7E shows an enlarged end of the layer. As shown in FIG. 7D this particular arrangement of conduits is in the form of a single length of conduit reciprocating in direction with a plurality of U-bend or 180 degree turning portions at either end. These act to change the direction of fuel within the conduit which in turn increases the length of the overall flow path of fuel within the hot exhaust gas environment created within the tail cone cavity 6. Heat transfer and fuel heating can thereby be optimised.

The diameter of tubes is primarily selected to fit this area in a small volume. Smaller diameter tubes are therefore better, but it is limited by mechanical and manufacturing concerns. For example 6 mm tubes may be used in one example. Smaller diameter tubes, such as 3 mm diameter may also be used.

As show in FIG. 7E a fluid, such as hydrogen fuel, is received from a fluid or fuel supply (for example a cryogenic tank) and communicated into one end of the conduit (H2 Inlet at FIG. 7E) and is then received at the other end of the conduit from H2 Outlet in FIG. 7E for communication to the fuel delivery system of the aircraft engine(s).

The U-bend sections may advantageously allow individual lengths or groups of conduits to be replaced as part of general maintenance or repair.

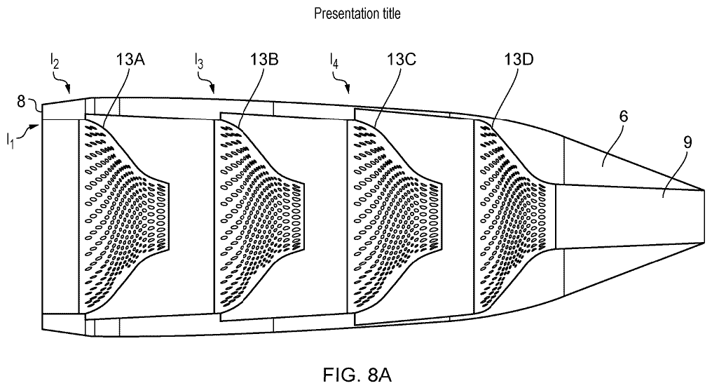

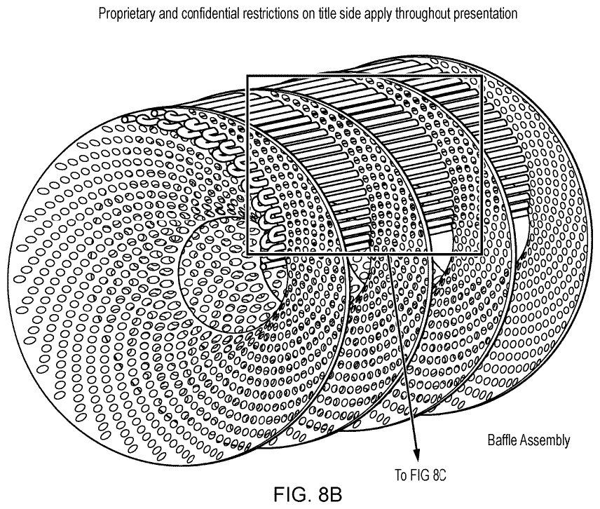

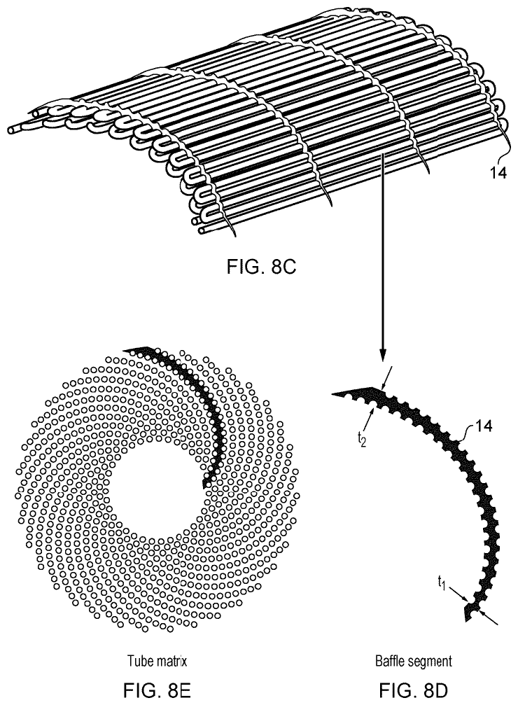

FIGS. 8A to 8E illustrate a further embodiment of an invention described herein. Specifically, FIGS. 8A to 8E show conduit support elements 13A, 13B, 13C and 13D spaced, axially, along the exhaust cone cavity 6.

Although 4 support elements 13A to 13D are shown in the example in FIG. 8A and FIG. 8B but it will be recognised that any suitable number of support elements may be used.

With a heat exchanger arranged and installed in a tail cone as described herein, there is a need for structural support, adding damping to the system as well as ensuring that the exhaust gas flow distribution is such that as much area as possible is “active” in the heat exchanger.

This design element will provide structural support, enable damping of vibrations. It will also simplify the assembly processes as well as used to guide the flow in the heat exchanger such that there are no “dead zone” that are not active in the exchanger.

In the example shown the support or baffle elements 13A to 13D are designed to accommodate a spiral arrangement of the conduits (as illustrated in the end on view of FIG. 8E). Thus, each conduit is secured by each baffle whilst simultaneously allowing for thermal expansion.

The baffles may prevent tube vibrations which represent a durability problem. Flow speeds in the heat exchanger may be relatively low (e.g. 30 m/s). Tube vibration causes fatigue in the tubes and supporting elements and therefore should be avoided. Conventional tube heat exchangers have wires or strips of sheet metal threaded through the tube banks to ensure constant distance between tubes and reduce vibrations.

Each of the supports or baffles 13A to 13D acts to guide the exhaust gases so as to flow evenly across the conduit or pipe bundle. An even flow distribution will result in a heat exchanger with minimum weight and highest compactness (minimal geometrical envelope needed). The compactness is necessary to eliminate/minimize the impact on other parts of the engine system that otherwise would require significant design changes to the nacelle (the tail cone).

The baffle design will also provide (amongst other advantages):
Structural support of the spiral conduits of the heat exchanger;
Damping of the spiral heat exchanger assembly;
Simplified assembly process; and
Enables pre-fabrication of integral tube segment e.g. bends and other features.

FIGS. 8C and 8D illustrates the curved supports 14 that locate the conduits in position in a generally curved or spiral form as illustrated in the end-on view in FIG. 8E. As shown the spacing of the conduits is achieved by the incremental increase in thickness t₁ to t₂ of the supports.

FIG. 8E shows a single support and ghost lines indicating the positions of respective conduits. It will be recognised that the spiral configuration maximises the conduit density of a given cross-sectional area whilst retaining a spacing between conduits to allow for exhaust gas circulation.

Returning to FIG. 8A the figure illustrates how the primary exhaust flow into the cavity 6 from inlet 8 is sub-divided or separated by the supports or baffles 13A to 13D.

As illustrated each baffle from 13A to 13D has a slightly larger outside diameter within the cavity with 13A having the smallest outside diameter and defining an inlet radius I₁. The last baffle 13D has the largest diameter and defines an inlet radius I₄

The intermediate baffles have correspondingly increasing outer diameters and increasing inlet radii I₂ and I₃ respectively. Thus, the inlet exhaust gas can be evenly distributed across the heat exchanger length to optimise efficiency.

It will be appreciated from FIGS. 8A to 8E that exhaust gas can be effectively introduced into the tail cone cavity and controlled to optimise the flow along and around the conduits forming the heat exchanger. The exhaust gas can then conveniently exit the cavity through outlet 9 in an axial direction to leave the engine and mix with the thrust and other exhaust gases leaving the aft of the engine.

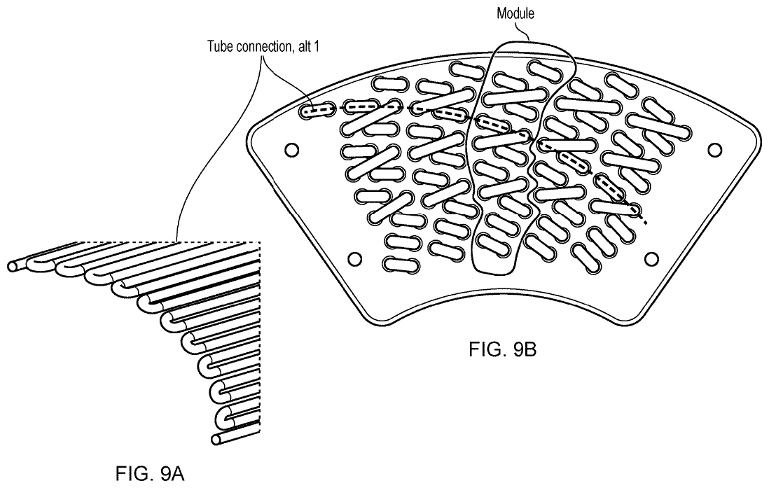

FIGS. 9A and 9B show a conduit interconnection at either end of the heat exchanger conduit assembly. The heat exchanger tubes are effectively a continuous path for fuel fluid flow reciprocating in direction towards the rear and front of the heat exchanger. At either end a 180 degree turn in fluid flow direction is required which can be achieved by the U bend illustrated in FIG. 9A.

As shown in FIG. 8E the tubes may be arranged in a generally spiral configuration.

The conduit U-bends at either end of the assembly are configured so as to achieve the optimal function of the tubes i.e. that the tubes or conduits are connected in series along a spiral. This is achieved by connecting the tubes from the innermost tube on a spiral, then the second to innermost and so on to the outermost tube; the fluid or fuel flows back and forth along the respective tube of the heat exchanger for an innermost tube to an outermost tube (or vice-versa). This is illustrated by the dashed line of tubes in FIG. 9B which corresponds to the arrangement in FIG. 9A

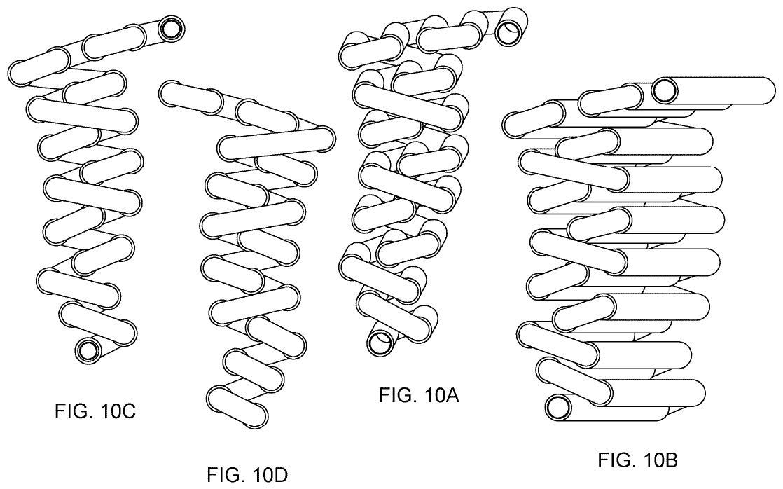

However, all tubes which have the same position along any spiral have the same function (temperature and flow direction) as one on any other spiral. To make a more compact “module” it is thus possible to connect e.g. tube 1 on spiral A with tube 2 on spiral B and then tube 3 on spiral C and so on. This is illustrated with reference to FIGS. 10A to 10D. In effect a modular arrangement of heat exchanger tubes can be provided which has a number of advantages.

One advantage of the compact modules is that they can be manufactured one by one and then assembled. Also if there is a need for inspection, test and repair the modules can be handled individually. Structurally modules can be stronger and stiffer by holding them together with baffle plates which are more compact.

According to the modified arrangement in FIGS. 10A to 10D the thermodynamic function of the arrangement can be maintained and the efficiency (heat transfer, weight, pressure losses) is unchanged. (Some tube bends become slightly longer, though, but this has only a marginal impact on weight and pressure losses).

Note that as each module is more narrow at the inner radius, here typically only one or two tubes are connected along a spiral, before stepping over to the next. Near the outer radius more tubes are connected along a spiral, before a bend goes to the next. (The number to connect along a spiral before stepping to the next is calculated from the number of spirals, the number of tubes per spiral, the tube inter-spacing and the spiral angle)

FIGS. 10A and 10B show the general way the tubes are connected at either end and how the straight lengths of tube extend between either U-bend at the ends of the heat exchanger module. As illustrated the module is tapered with 5 straight pipe connections at the outermost point and a single connection at the radially innermost point.

FIGS. 10C and 10D are end views of a pair of modules. Returning to FIG. 9B an end plate of a heat exchanger is shown with a module corresponding to FIGS. 10A to 10D being highlighted.

By dividing the heat exchanger into a plurality of modules the heat exchanger can be divided into segments of the circumference of the heat exchanger. Each module can be connected to an adjacent (or other) module at one or both ends using one or more connectors. It will be recognised that creating a heat exchanger using a modular arrangement described herein provides a number of advantages as discussed below. The arrangement shown in FIGS. 10A to 10D provides the optimal function the tubes need to be connected in series along a spiral.

Specifically, the innermost tube on a spiral, then the second to innermost and so on to the outermost tube. However, all tubes which have the same position along any spiral have the same function (temperature and flow direction) as one on any other spiral. To make a more compact “module” it is thus possible to connect e.g. tube 1 on spiral A with tube 2 on spiral B and then tube 3 on spiral C and so on.

The advantage of the compact modules is that they can be manufactured one by one and then assembled. Furthermore, if there is a need for inspection, test and repair the modules can be handled individually. Structurally modules can be stronger and stiffer by holding them together with baffle plates (as shown for example in FIG. 9B) which are more compact.

As the thermodynamic function of the alternatives is the same, the efficiency (heat transfer, weight, pressure losses) is unchanged. Some tube bends may become slightly longer but the effect is marginal.

As described above each module is a sector which may advantageously be identical.

As also illustrated in FIGS. 10A to 10D the spacing of adjacent tubes forming each module may be varied. For example, the centre to centre spacing of tubes towards the inner radius of the module (measured from the central axis of the heat exchanger) may be greater than the centre to centre spacing of adjacent tubes towards the outer radius of the module. In effect a non-uniform distribution of tube spacings may be provided. More specifically, the matrix should be dense at the outer radius and more sparse towards the center. This will limit flow velocities and pressure drop towards the center of the heat exchanger.

Thus, each module, and thereby the heat exchanger as a whole, can be optimised in performance for a specific application.

1.-28. (canceled)

29. An aircraft fluid heating arrangement, comprising:
an exhaust cone for a gas turbine engine,
the exhaust cone having an outer body defining an internal cone cavity, and
the internal cone cavity comprising one or more conduits passing therethrough for communicating fluid through the cavity;
wherein the outer body of the exhaust cone comprises at least one inlet and at least one outlet to allow exhaust gas to pass into through and out of the exhaust cone.

30. The fluid heating arrangement of claim 29, further comprising a fluid inlet and fluid outlet allowing for fluid to be communicated to and from the conduit(s) within the cavity.

31. The fluid heating arrangement of claim 29, wherein the one or more conduits are arranged so as to cause fluid to flow in a generally alternating direction between the fore and rear of the cone in an exhaust gas flow direction.

32. The fluid heating arrangement of claim 29, wherein:
the one or more conduits are in the form of a generally cylindrical heat exchanger having a plurality of pipes extending between the fore and aft of the cavity and defining one or more fluid flow paths within the cavity; and/or
the spacing between adjacent conduits increases towards the central axis of the heat exchanger; and/or
the conduits are divided into discrete groups, each group forming a sub-set or module of a heating arrangement body.

33. The fluid heating arrangement of claim 32, wherein a sub-set or module is selectively removable from the heating arrangement.

34. The fluid heating arrangement of claim 33, wherein modules are fluidly interconnected at one or both ends of a module to an adjacent module.

35. The fluid heating arrangement of claim 29, wherein the at least one inlet is in the form of one or more annular circumferentially extending inlet(s) arranged to communicate exhaust gas from an exhaust of an associated engine into the cavity.

36. The fluid heating arrangement of claim 29, wherein the outlet from the cavity is axially located with respect to the axis of rotation of the exhaust cone.

37. The fluid heating arrangement of claim 29, wherein the cavity comprises a plurality of conduit supports/baffles extending across a portion of the cross-sectional area of the exhaust cone and comprising a plurality of apertures arranged to receive and support an associated conduit.

38. The fluid heating arrangement of claim 37, wherein:
the supports/baffles are spaced along the length of the cavity from exhaust inlet to exhaust outlet, and/or
the supports/baffles have increasing outer radii towards the exhaust outlet; and/or
the supports/baffles each have a generally truncated cone shape and comprise a central open end for communicating exhaust gas towards the exhaust of the tail cone.

39. The fluid heating arrangement of claim 38, wherein the sides of each generally truncated cone shape comprise a concave curved profile when viewed in cross-section.

40. The fluid heating arrangement of claim 29, further comprising a primary heat exchanger arranged to exchange heat between a fuel for use in an engine and a fluid arranged to flow through the plurality of conduits within the exhaust cone.

41. The fluid heating arrangement of claim 40, wherein the primary heat exchanger is arranged to be in fluid communication with a cryogenic fuel source and a fuel delivery system of an engine and the plurality of conduits are arranged to exchange heat from exhaust gas to a fluid contained within the conduits.

42. The fluid heating arrangement of claim 29, wherein the volume of exhaust gas flowing through the exhaust cone and over the conduits is predetermined and the inlet(s) and/or outlet(s) is/are configured to allow a predetermined percentage or volume of exhaust gas to pass through the cone.

43. The fluid heating arrangement of claim 29, wherein the volume of exhaust gas flowing through the exhaust cone and over the conduits may be selectively controlled by means of one or more exhaust gas control arrangements arranged to control the ingress and/or egress of exhaust gas into or out of the cone.

44. A cryogenic fuel heating arrangement for a gas turbine engine, comprising:
a heat exchanging apparatus contained within an exhaust tail cone of a gas turbine engine,
the exhaust tail cone having an outer body defining an internal cone cavity, and
the internal cone cavity comprising a heat exchanger in fluid communication with a cryogenic fuel tank and an engine fuel system,
wherein the outer body of the exhaust cone comprises at least one inlet and at least one outlet to allow engine exhaust gas to pass through the heat exchanging apparatus to transfer energy from the exhaust gas to the cryogenic fuel.

45. The cryogenic fuel heating arrangement for a gas turbine engine of claim 44, wherein the volume of exhaust gas flow is selectively controlled in response to control signals from a control apparatus.

46. The cryogenic fuel heating arrangement for a gas turbine engine of claim 44, wherein the cryogenic fuel is liquid hydrogen.

47. A method of heating a fuel or fluid for a gas turbine engine, the engine comprising a fuel or fluid heating arrangement comprising an exhaust cone for a gas turbine engine, the exhaust cone having an outer body defining an internal cone cavity, the internal cone cavity comprising one or more conduits passing therethrough for communicating fuel or fluid through the cavity, and wherein the outer body of the exhaust cone comprises at least one inlet and at least one outlet to allow exhaust gas to pass into through and out of the exhaust cone, the method comprising:
(a) causing fuel or fluid to be communicated into the conduit(s) from a fuel or fluid source;
(b) causing exhaust gas from the engine to pass through the exhaust cone and around the conduits to cause heat transfer to the fuel or fluid contained therein; and
(c) communicating heated fuel or fluid to a gas turbine engine.

48. The method of claim 47, wherein the fuel or fluid is a cryogenic liquid hydrogen fuel.
